(19) United States
(12) Patent Application Publication
(10) Pub. No.: US 2022/0184428 A1
(43) Pub. Date: Jun. 16, 2022

(54) CHEMICAL AND BIOLOGICAL PROTECTIVE SHIRT AND HOOD

(71) Applicant: U.S. Government as Represented by the Secretary of the Army, Natick, MA (US)

(72) Inventor: Stephanie M Tew, Salem, VA (US)

(21) Appl. No.: 16/212,751

(22) Filed: Dec. 7, 2018

Related U.S. Application Data
(60) Provisional application No. 62/597,552, filed on Dec. 12, 2017.

(51) Int. Cl. A62B 17/04; A41D 1/04; A41D 27/02; A62B 17/00

(52) U.S. Cl. CPC A62B 17/04; A41D 1/04; A41D 13/11; A62B 17/006; A41D 2200/20; A41D 27/02

(57) ABSTRACT

The disclosed subject matter relates to chemical and biological protective hood and garments including the hood. The hood includes a hood body having a face opening in the hood body, at least one section of a non-stretch protective composite fabric, at least one section of a stretch protective composite fabric and a face opening liner including a non-stretch fabric cover layer and an aerosol protective layer and does not include a vapor protective layer, the face opening liner being attached to the hood body and positioned around the perimeter of the face opening.

### CROSS-REFERENCE TO RELATED APPLICATIONS

This application claims priority to and the benefit of U.S. Provisional Patent Application Ser. No. 62/597,552 filed Dec. 12, 2017, the disclosure of which is incorporated herein by reference in its entirety.

### STATEMENT OF GOVERNMENT INTEREST

The invention described herein may be manufactured and used by or for the U.S. Government for governmental purposes without the payment of any royalties thereon or therefor.

### FIELD

This disclosure relates to chemical and biological protective ensembles and methods of manufacture and components thereof.

### BACKGROUND

Certain chemical and biological agents can be destructive weapons used to terrorize, incapacitate, harm, or kill. Such agents can pose a real and growing threat to military personnel, as well as civilians. As a result, there is a growing need to protect both the military personnel and civilians, and other life (such as animals) from the release of such agents.

Some chemical and biological protective garments, in particular, shirts and other protective clothing that protect a wearer from around the waist and above (e.g., the torso, arms and head) can provide limited protection to the wearer, particularly around the face, even if a protective mask or other facial protective device is used. For example, the interface between the opening of a hood and a protective mask can allow for infiltration of chemical vapor or aerosol into the ensemble, thereby adversely affecting the wearer by subjecting that person to the chemical vapor or aerosol.

It would be advantageous to have a chemical and biological protective garment and hood that provides better protection from external chemical vapor or aerosol agents.

### SUMMARY

In one embodiment, a hood for an article of clothing for protecting a wearer from chemical and biological agents infiltrating the interior of the hood is provided. The hood includes a hood body having a face opening in the hood body, at least one section of a non-stretch protective composite fabric, at least one section of a stretch protective composite fabric and a face opening liner including a non-stretch fabric cover layer and an aerosol protective layer and does not include a vapor protective layer, the face opening liner being attached to the hood body and positioned around the perimeter of the face opening.

In another embodiment, a hood for an article of clothing for protecting a wearer from chemical and biological agents infiltrating the interior of the hood is provided. The hood includes a hood body having a face opening in the hood body, at least one section of a non-stretch protective composite fabric extending from the forehead region of the wearer over the top of the head and scalp and down the back of the back of the head and back of the neck, at least one section of a stretch protective composite fabric on each side of the head of the wearer and a face opening liner attached to the hood body and positioned around the perimeter of the face opening, the face opening liner including a tubular structure with a draw string or cord disposed therein, the tubular structure including a non-stretch fabric cover layer and an aerosol protective layer and does not include a vapor protective.

In another embodiment, an article of clothing for protecting a wearer from chemical and biological agents infiltrating the interior of the article. The article of clothing includes a body portion covering the torso and arms of the wearer and a hood connected to the body portion. The hood includes a hood body having a face opening in the hood body, at least one section of a non-stretch protective composite fabric, at least one section of a stretch protective composite fabric and a face opening liner including a non-stretch fabric cover layer and an aerosol protective layer and does not include a vapor protective layer, the face opening liner being attached to the hood body and positioned around the perimeter of the face opening.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1A and 1B are schematic illustrations of the front and back of an embodiment of the present disclosure;

FIG. 2 is a schematic illustration of a cross section of a fabric embodiment of the present disclosure;

FIG. 3 is a schematic illustration of a cross section of a fabric embodiment of the present disclosure;

FIGS. 4A, 4B and 4C are schematic illustrations of the front, back and side of an embodiment of the present disclosure;

FIG. 4D is a schematic illustration of a cross section of the side view of embodiment of FIG. 4C.

FIG. 4E is a schematic illustration of an embodiment of a face opening liner; and

FIG. 4F is a schematic illustration of the front view of FIG. 4A with a face protection device.

### DETAILED DESCRIPTION

Aspects of the disclosed embodiments are directed to chemical and biological protective hooded garments (i.e., a pull over shirt with a hood worn to protect the upper part of the human body, preferably without a zipper) and components thereof.

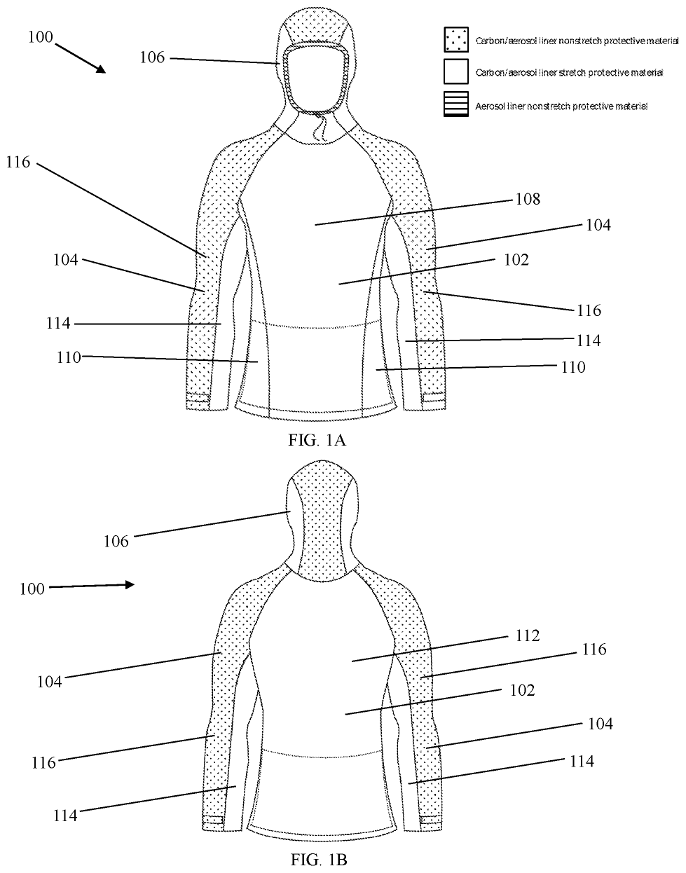

One embodiment of a protective garment is illustrated in FIGS. 1A and 1B. This embodiment is a one-piece pull over article of clothing including a shirt 100 (the front view shown in FIG. 1A and the back view shown in FIG. 1B) The shirt includes sections of non-stretch protective composite fabric that includes vapor protective (e.g., a carbon-based or other vapor protective layer) and aerosol protective composite fabrics of the present disclosure (dots), stretch protective composite fabric that includes vapor protective (e.g., a carbon-based or other vapor protective layer) and aerosol protective composite fabrics of the present disclosure (white areas) and non-stretch composite fabric that includes aerosol protective composite fabrics of the present disclosure (bold line filled areas) as shown in the legend included in the FIG. 1A. The difference between stretch protective composite fabrics and non-stretch protective composite fabric can be related to the fabric cover layers used therein. A stretch protective composite fabric may include a fabric layer that stretches (for example a knit fabric material) and, thereby, provides a protective composite fabric that can stretch. A non-stretch protective composite fabric may include a fabric layer that does not stretch (for example a woven fabric material) and, thereby, provides a protective composite fabric that cannot stretch. The different stretch vapor and aerosol protective composite fabric sections, non-stretch vapor and aerosol protective composite fabric sections and non-stretch aerosol protective composite fabric sections can be connected by, for example, joining the seams of adjacent sections using traditional cut and sew techniques. Like sections made of the same material may be integral or connected to one another similarly.

As illustrated in FIGS. 1A and 1B, shirt 100 includes a torso 102 that is intended to fit over the shoulders, back and chest of the wearer, sleeves 104 that are intended to cover the arms of the wearer and a hood 106 that is intended to cover the head and neck of the wearer and can be detachable or integral, preferably integral. Details of hood 106 are included subsequently in FIGS. 5A-5F. Shirt 100 has sections of stretch vapor and aerosol protective composite fabric including fabric shirt front section 108, shirt side panel sections 110 that may be integral or connected to shirt back panel 112 and shirt inner sleeve sections 114 that are part of sleeves 104. Shirt 100 has sections of non-stretch vapor and aerosol protective composite fabric including shirt outer sleeve sections 116. Hood 106 includes sections of stretch vapor and aerosol protective composite fabric, non-stretch vapor and aerosol protective composite fabric and non-stretch aerosol protective composite fabric as will be described in more detail below.

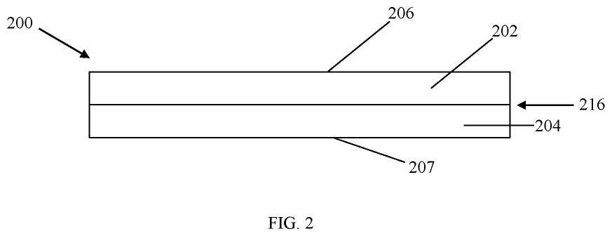

FIG. 2 is illustrative of aspects of one embodiment of a protective composite fabric 200. Protective composite fabric 200 includes fabric cover layer 202 and an aerosol protective layer 204. The fabric cover layer 202 can include non-stretch fabrics (for example a woven fabric material) that can also be, for example, fire resistant or non-fire-resistant materials. Woven fabric materials can be, for example, aramid blends, aramid-based flame-resistant material, cotton, nylon, blends such as cotton blends and nylon/cotton blends, polyester or polyester blends. The weight of fabric cover layer 202 can range from about 2.0 osy (ounces per square yard) to about 7.5 osy, preferably from about 4.5 osy to about 6.0 osy. External surface 206 of fabric cover layer 202 can be designed to face the external environment (e.g. the outside of the garment in which protective composite fabric 200 is used that can include sunlight, rain, gas agents, aerosols and other external environmental conditions) can also optionally include a repellant coating, such as, for example, a liquid repellant coating (such as silica based liquid repellent coatings or perfluoronated carbon based liquid repellent coatings). Internal surface 207 of aerosol protective layer 204 can be designed to face the internal environment (e.g. closer to the body of the wearer of a garment protective composite fabric 200 is used). The aerosol protective layer 204 can be a material that is substantially impervious to penetration by aerosol particles (such as dust and aerosolized chemical agents, for example, dusty mustard, or biological agents) and can include material, such as, for example, expanded polytetrafluoroethylene (ePTFE), preferably microporous ePTFE, nanofibers such as polyurethane, polysulfone, nylon-6, polyvinylidene difluoride, polyether sulfone, or other polymer and microfibers such as polypropylene microfibers or microfibers of another polymer. The weight of aerosol protective layer 204 can range from about 0.2 osy to about 2.0 osy, preferably from about 0.5 osy to about 1.0 osy.

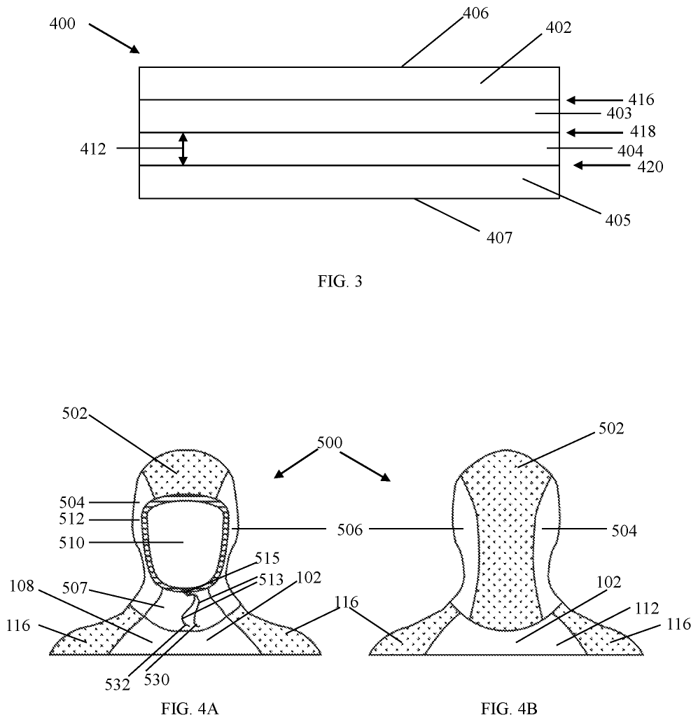

FIG. 3 is illustrative of aspects of other embodiments of a protective composite fabric 300. Protective composite fabric 300 includes fabric cover layer 302, an aerosol protective layer 304 and a vapor protective layer 306. The fabric cover layer 302 is as included above in the disclosure of fabric cover layer 202 in FIG. 2. External surface 308 of fabric cover layer 302 can be designed to face the external environment as described in external surface 206 in FIG. 2 and can also optionally include a repellant coating, such as those included above in FIG. 2. The weight of fabric cover layer 302 is as included above in the disclosure for fabric cover layer 202. Aerosol protective layer 304 is as included above in the disclosure of aerosol protective layer 204 in FIG. 2. The weight of aerosol protective layer 304 is as included above in the disclosure for aerosol protective layer 204.

Internal surface 307 of vapor protective layer 306 can be designed to face the internal environment is as included above in the disclosure for internal surface 207.

FIG. 3 is illustrative of aspects of other embodiments of a protective composite fabric 400. Protective composite fabric 400 includes fabric cover layer 402, an aerosol protective layer 403, a vapor protective layer 404 and a comfort layer 405. The fabric cover layer 402 is as included above in the disclosure of fabric cover layer 202 in FIG. 2. External surface 406 of fabric cover layer 402 can be designed to face the external environment as described in external surface 206 in FIG. 2 and can also optionally include a repellant coating, such as those included above in FIG. 2. The weight of fabric cover layer 402 is as included above in the disclosure for fabric cover layer 202. Aerosol protective layer 403 is as included above in the disclosure of aerosol protective layer 204 in FIG. 2. The weight of aerosol protective layer 403 is as included above in the disclosure for aerosol protective layer 204.

The vapor protective layer 404 can be a material that substantially prevents penetration by chemical agents including mustard and other blister agents, Sarin, Soman, VX and other nerve agents and chemical warfare agents but capable of allowing water vapor transfer and can include material such as, for example, semi-permeable membranes such as Chempak (a product from WL Gore) or ChemCAT (a product from Stedfast). The vapor protective layer 404 can also be a sorptive material that adsorbs chemical agents and can be, for example carbon-based liners including activated carbon cloth such as Zoreflex or Stedchem, carbon beads such as the Saratoga series of liners, or carbon particles attached with binders to a polymer matrix such as made by Freudenberg. The thickness 412 of vapor protective layer 404 if a semi-permeable membrane can be about 0.5 mils to 10 mils and if vapor protective layer 404 is a sorptive material, it can have a sorptive loading of about 25-about 250 g/m2. Preferably, the vapor protective layer includes carbon-based liner, such as, for example, those included in the above disclosure.

Comfort layer 405 is intended to have internal surface 407 in contact with the wearer of a garment that includes protective composite fabric 400 and/or other garments worn by the wearer of a garment that includes protective composite fabric 400 or to face the internal environment as described in internal surface 207 in FIG. 2. Comfort layer 405 can include, for example, a cotton knit or cotton blend knit or other knit or woven fabric that provides comfort against the skin. The weight of comfort layer 405 can range from about 0.5 osy to about 4.0 osy, preferably from about 1.0 osy to about 2.5 osy.

Lamination for affixing the layers of embodiments of protective composite fabrics of the present disclosure may include dot matrix adhesives, web adhesives, other adhesive patterns or methods including gravure rolls, reverse gravure rolls, nanofiber adhesives and other methods. Preferably, the lamination eliminates or substantially eliminates air gaps from the boundary between adjacent layers, examples of such boundaries can include boundary 216 in FIG. 2 and boundaries 416, 418 and 420 in FIG. 3. As a result of removing or substantially removing air gaps, thermal transfer, for example, heat generated from the wearer of garment constructed of an embodiment of the protective composite fabrics of the present disclosure, is more efficient from one side of the protective composite fabric to the other side than if such air gaps were present. This is because air gaps in a protective composite fabric layer can contribute to poor heat transfer because air is an insulator.

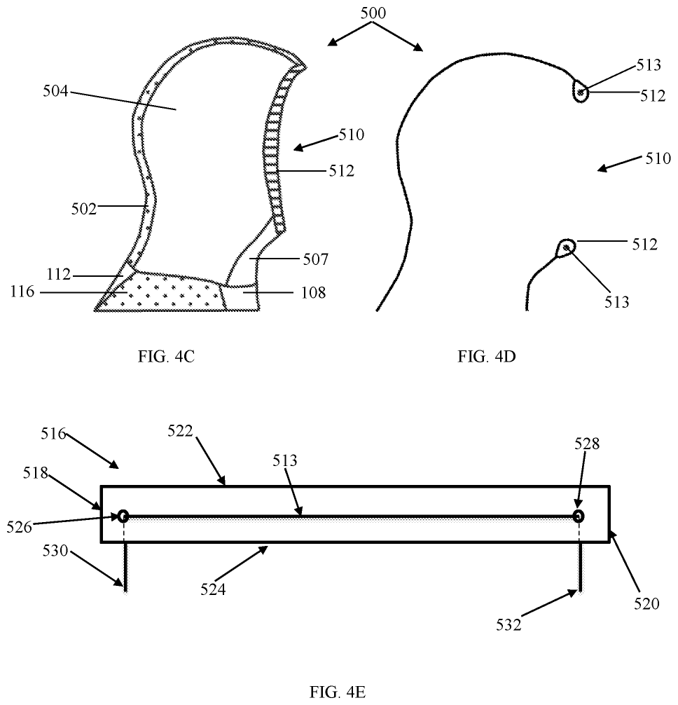

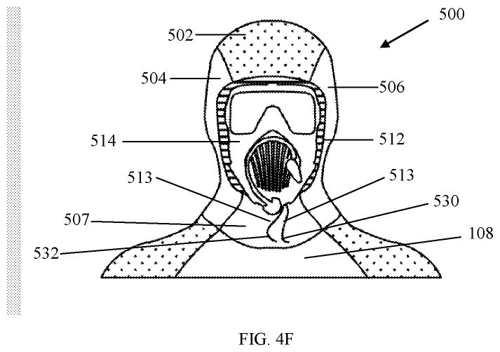

Hood 106 is shown in more detail as hood 500 in FIGS. 4A-4F and includes a face opening 510, a non-stretch protective composite fabric that includes aerosol and vapor protective composite fabrics of the present disclosure (dots), for example, the embodiment of FIG. 3 made with a non-stretch fabric cover layer and non-stretch comfort layer; stretch protective composite fabric that includes protective composite fabrics of the present disclosure (white areas), for example, the embodiment of FIG. 3 made with a stretch fabric cover layer and stretch comfort layer; and a non-stretch aerosol protective fabric (bold line filled areas), for example, the embodiment of FIG. 2 made with a non-stretch fabric cover layer, as shown in the legend included in the figures.

Hood 500 has a section of non-stretch protective composite fabric including hood head top and back section 502 that can extend from the forehead of the wearer over the top of the head and scalp and down the back of the back of the head and back of the neck. Hood 500 has sections of stretch protective composite fabric including hood side sections 504 and 506 that can cover the sides of the head of the wearer including the ears and side of the head and neck, a hood front neck 507 that can cover the chin and front of the neck of the wearer and a face opening 510 that is encircled by a face opening liner 512. Face opening liner 512 can be made of a non-stretch aerosol protective composite fabric (such as, for example, the embodiment of FIG. 2 included above) that may generally conform to the face surface of a wearer positioned therein and substantially deter the passage of chemical and/or biological agents into the interior of the hood. Face opening 510 and face opening liner 512 may be configured to cooperate with a chemical and/or biological agent resistant mask or other apparatus 514 (including a breathing apparatus) to protect the wearer from such chemical and/or biological agents. Face opening liner 512 also includes a draw string or cord 513 within the face opening liner. The ends 530 and 532 of the drawing string or cord 513 can extend from the interior of the face opening liner 512, the ends connected through a cord lock 515. As a result, the drawing string can be tensioned to allow the face opening liner to conform to the face surface of a wearer or a chemical and/or biological agent resistant mask or other apparatus 514 (including a breathing apparatus) to protect the wearer as shown in FIG. 4F. As a result of the face opening liner including non-stretch protective fabric material and a aerosol protective layer, the face opening liner 512 conforms better to the face surface of a wearer or a protective mask at least partially covering the face surface of the wearer, for example, a chemical and/or biological agent resistant mask or other apparatus 514 (including a breathing apparatus) with minimal, little or no gapping than bulkier materials, such as protective fabric materials (such as for example, the non-stretch protective composite fabric that includes aerosol and vapor protective composite fabrics of the present disclosure), for example, the embodiment of FIG. 4 made with a non-stretch fabric cover layer and non-stretch comfort layer and, thereby provides improved protection from chemical and/or biological agent penetrating the inside of the hood and the wearer.

Face opening liner 512 is preferably connected to the edge of the non-stretch protective composite fabric that includes aerosol and vapor protective composite fabrics of the present disclosure (dots) and the stretch protective composite fabric that includes protective composite fabrics of the present disclosure (white areas) sections of the hood. Face opening liner 512 is positioned around the perimeter of the face opening 510 and includes a generally tubular shape in which draw string or cord 513 (preferably a elasticized draw string or cord) encircling the interior thereof as shown in FIG. 4D in which draw string or cord 513 resides in face opening liner 512, the latter attached to the hood structure adjacent the face opening 510, preferably adjacent to the chin of the wearer. The ends of draw string or cord 513 extend through apertures in face lining 512 so that they are can used to tension the draw string or cord 513 as described above. In one embodiment, draw string or cord 513 can be tied together or connected to a device to maintain tension such as for example a cord lock 515. The face opening liner 512 can be an aerosol liner cover fabric used as a binding/channel for the draw string or cord 513 at the interface of the face of the wearer or a chemical and/or biological agent resistant mask or other apparatus 514 (including a breathing apparatus) to protect the wearer as shown in FIG. 4F. When the face opening liner 512 is tensioned, the use of low bulk material reduces large folds and leak paths.

One embodiment of face opening liner 512 can be formed from a generally rectangular piece of a non-stretch aerosol protective fabric 516 as shown in FIG. 4E. For example, face opening liner 512 made of fabric 516 with edges 518, 520, 522 and 524 as well as draw string or cord 513 that extend through apertures 526 and 528, such as, for example, eyelets, and has draw string or cord ends 530 and 532. For this exemplified embodiment, the tubular structure of face opening liner 512 can be formed by joining edge 518 to edge 520 and joining edge 522 to edge 524.

The various sections of stretch protective composite fabric are positioned in the embodiment disclosed herein so as to allow for more ease in freedom of movement by the wearer. Such as, for example, shirt front section 108, hood side sections 504 and 506 and hood front neck section 508 for head and neck movement, shirt side panel sections 110 and shirt back panel 112 for torso movement and inner sleeve sections 114 for arm movement as well as facilitating the ease in which the wearer puts on the garment since it is a pullover garment.

This written description uses examples as part of the disclosure, including the best mode, and also to enable any person skilled in the art to practice the disclosed implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A hood for an article of clothing for protecting a wearer from chemical and biological agents infiltrating the interior of the hood, comprising a hood body including
a. a face opening in the hood body;
b. at least one section of a non-stretch protective composite fabric;
c. at least one section of a stretch protective composite fabric; and
d. a face opening liner including a non-stretch fabric cover layer and an aerosol protective layer and does not include a vapor protective layer, the face opening liner being attached to the hood body and positioned around the perimeter of the face opening.

2. The hood of claim 1, wherein the non-stretch protective composite fabric includes a non-stretch fabric cover layer, an aerosol protective layer and a vapor protective layer.

3. The hood of claim 2, wherein the vapor protective layer includes a carbon-based liner.

4. The hood of claim 1, wherein the stretch protective composite fabric includes a stretch fabric cover layer, an aerosol protective layer and a vapor protective layer.

5. The hood of claim 4, wherein the vapor protective layer includes a carbon-based liner.

6. The hood of claim 1, wherein the face opening liner includes a tubular structure with a draw string or cord disposed therein such that when tension is applied to the draw string or cord, the face opening liner conforms to the surface of the face of the wearer or the surface of a protective mask covering the face of the wearer.

7. The hood of claim 7, wherein the protective mask is resistant to at least one of a chemical agent and a biological agent.

8. A hood for an article of clothing for protecting a wearer from chemical and biological agents infiltrating the interior of the hood, comprising a hood body including
a. a face opening in the hood body;
b. at least one section of a non-stretch protective composite fabric extending from the forehead region of the wearer over the top of the head and scalp and down the back of the back of the head and back of the neck; and
c. at least one section of a stretch protective composite fabric on each side of the head of the wearer; and
d. a face opening liner attached to the hood body and positioned around the perimeter of the face opening, the face opening liner including a tubular structure with a draw string or cord disposed therein, the tubular structure including a non-stretch fabric cover layer and an aerosol protective layer and does not include a vapor protective.

9. The hood of claim 8, wherein the stretch protective composite fabric includes a stretch fabric cover layer, an aerosol protective layer and a vapor protective layer.

10. The hood of claim 9, wherein the vapor protective layer includes a carbon-based liner.

11. The hood of claim 8, wherein the non-stretch protective composite fabric on each side of the head of the wearer includes a non-stretch fabric cover layer, an aerosol protective layer and a vapor protective layer.

12. The hood of claim 11, wherein the vapor protective layer includes a carbon-based liner.

13. The hood of claim 8, wherein when tension is applied to the draw string or cord, the face opening liner conforms to the surface of the face of the wearer or the surface of a protective mask covering the face of the wearer.

14. The hood of claim 13, wherein the protective mask is resistant to at least one of a chemical agent and a biological agent.

15. An article of clothing for protecting a wearer from chemical and biological agents infiltrating the interior of the article, comprising:
a. a body portion covering the torso and arms of the wearer; and
b. a hood connected to the body portion, the hood comprising a hood body including
i. a face opening in the hood body;
ii. at least one section of a non-stretch protective composite fabric;
iii. at least one section of a stretch protective composite fabric; and
iv. a face opening liner including a non-stretch fabric cover layer and an aerosol protective layer and does not include a vapor protective layer, the face opening liner being attached to the hood body and positioned around the perimeter of the face opening.

16. The article of clothing of claim 15, wherein the body portion includes
a. at least one section of a non-stretch protective composite fabric; and
b. at least one section of a stretch protective composite fabric.

17. The article of clothing of claim 15, wherein the article is a pullover style article of clothing.

18. The article of clothing of claim 15, wherein the face opening liner includes a tubular structure with a draw string or cord disposed therein such that when tension is applied to the draw string or cord, the face opening liner conforms to the surface of the face of the wearer or the surface of a protective mask covering the face of the wearer.

19. The hood of claim 15, wherein at least one section the non-stretch protective composite fabric extends from the forehead region of the wearer over the top of the head and scalp and down the back of the back of the head and back of the neck.

20. The hood of claim 15, wherein the at least one section of the stretch protective composite fabric is on each side of the head of the wearer.
